(19) United States
(12) Patent Application Publication
(10) Pub. No.: US 2015/0198244 A1
(43) Pub. Date: Jul. 16, 2015

(54) WORK VEHICLE

(71) Applicant: KOMATSU LTD., Tokyo (JP)

(72) Inventor: Yutaka Ono, Komatsu-shi (JP)

(21) Appl. No.: 14/352,431

(22) PCT Filed: Jan. 10, 2014
(86) PCT No.: PCT/JP2014/050335

§ 371 Date: Apr. 17, 2014

(51) Int. Cl. F16H 61/4165; F16H 61/462; F01P 7/04; F01P 1/06; F01P 5/04

(52) U.S. Cl. CPC F16H 61/4165; F01P 1/06; F01P 5/04; F01P 7/044; F16H 61/462

(57) ABSTRACT

A motor grader includes a control unit configured to set a current value for driving an electromagnetic proportional control valve based on a set of current value information. The control unit is configured to correct the set current value based on a fan rotation speed detected by a rotation sensor. The set of current value information has a low current value range (A), a middle current value range (B) and a high current value range (C), in each of which the fan rotation speed is increased or reduced in accordance with the current value. An absolute value of an increase or reduction ratio of the fan rotation speed is less in the low current value range (A) and the high current value range (C) than in the middle current value range (B).

### CROSS-REFERENCE TO RELATED APPLICATIONS

This application is a U.S. National stage application of International Application No. PCT/JP2014/050335, filed on Jan. 10, 2014. This U.S. National stage application claims priority under 35 U.S.C. §119(a) to Japanese Patent Application No. 2013-271706, filed in Japan on Dec. 27, 2013, the entire contents of which are hereby incorporated herein by reference.

### BACKGROUND

1. Field of the Invention

The present invention relates to a work vehicle.

2. Background Information

A work vehicle, such as a motor grader, is equipped with a cooling fan for ventilating a cooling object such as a radiator. The cooling fan is driven by a hydraulic motor, whereas the hydraulic motor is driven by means of operating oil to be supplied thereto from a hydraulic pump. A fan rotation speed, which is the rotation speed of the cooling fan, varies in accordance with the amount of the operating oil to be supplied to the hydraulic motor. Further, the amount of the operating oil to be fed to the hydraulic motor is regulated by an electromagnetic proportional control valve.

This electromagnetic proportional control valve is controlled by a control unit. The control unit controls the electromagnetic proportional control valve by varying a current value to be outputted to the electromagnetic proportional control valve. When the control unit thus controls the electromagnetic proportional control valve, the amount of the operating oil to be fed to the hydraulic motor is regulated. As a result, the fan rotation speed can be regulated.

The fan rotation speed is regulated in accordance with the temperature of the cooling object or so forth. For example, a temperature sensor detects the temperature of coolant water flowing through the radiator or so forth. Then, the control unit sets an appropriate fan rotation speed (a set value) in accordance with the temperature detected by the temperature sensor (see Japan Laid-open Patent Application Publication No. JP-A-2013-209940).

### SUMMARY

However, individual differences are produced in manufacturing hydraulic motors and so forth. Therefore, even when the control unit outputs a current value to the electromagnetic proportional control valve to rotate the cooling fan at a set value, the cooling fan may not be rotated with the set value. It should be noted that a drawback of fuel consumption degradation is produced when the actual fan rotation speed is greater than the set value, whereas a drawback of potential overheat risk is produced when the actual fan rotation speed is less than the set value.

It is an object of the present invention to rotate a cooling fan at an appropriate fan rotation speed.

A work vehicle according to an aspect of the present invention includes an engine, a cooling fan, a hydraulic pump, a hydraulic motor, an electromagnetic proportional control valve, a rotation sensor, and a control unit. The hydraulic pump is configured to be driven by the engine. The hydraulic motor is configured to be driven by means of an operating oil to be discharged from the hydraulic pump and rotate the cooling fan. The electromagnetic proportional control valve is configured to regulate an amount of the operating oil to be supplied to the hydraulic motor in response to a command value from the control unit. The rotation sensor is configured to detect a fan rotation speed of the cooling fan. The control unit is configured to set a current value for driving the electromagnetic proportional control valve based on a set of current value information indicating a correspondence between the fan rotation speed and the current value. Further, the control unit is configured to correct the set current value based on the fan rotation speed detected by the rotation sensor. The set of current value information has first and second current value ranges in each of which the fan rotation speed is increased or reduced in accordance with the current value. The first current value range and the second current value range are continuous to each other. An absolute value of a ratio of an increase or reduction amount of the fan rotation speed with respect to an increase or reduction amount of the current value is less in the second current value range than in the first current value range.

According to the present configuration, the control unit is configured to set the current value for driving the electromagnetic proportional control valve. Further, the control unit is capable of correcting the set current value based on the fan rotation speed detected by the rotation sensor. As a result, the electromagnetic proportional control valve is driven by a current with a more appropriate value; a more appropriate amount of the operating oil is supplied to the hydraulic motor; and accordingly, the actual fan rotation speed approaches a set value. In other words, the cooling fan can be rotated at a more appropriate fan rotation speed.

The following drawback is herein caused where the set of current value information has only the first current value range as a current value range in which the fan rotation speed is increased or reduced in accordance with the current value. The fan rotation speed is not increased or reduced in accordance with the current value in current value ranges other than the first current value range. In other words, the fan rotation speed becomes constant even when the current value varies in current value ranges other than the first current value range. Therefore, a drawback is produced that the control unit cannot correct the set current vale to a current value outside the first current value range. It should be noted that, when the amount of the operating oil to be supplied to the hydraulic motor becomes greater than an optimal value as the result that the control unit does not correct the current value, a drawback is produced that the fan rotation speed becomes greater than the set value and fuel consumption rate is deteriorated. On the other hand, when the amount of the operating oil to be supplied to the hydraulic motor becomes less than the optimal value as the result that the control unit does not correct the current value, a drawback is produced that the fan rotation speed becomes less than the set value and overheating can occur.

In comparison with the above, the control unit of the work vehicle according to an exemplary embodiment of the present invention has the second current value range as well as the first current value range as the current value ranges in each of which the fan rotation speed is increased or reduced in accordance with the current value. Therefore, when the actual fan rotation speed is deviated from the set value, the control unit can correct the set current value not only to a current value within the first current value range but also to a current value within the second current value range. As a result, the control unit can correct the set current value to a current value within a wider range, and a more appropriate amount of the operating oil can be supplied to the hydraulic motor. Therefore, the cooling fan can be rotated at a more appropriate fan rotation speed.

Further, the absolute value of the ratio of the increase or reduction amount of the fan rotation speed with respect to the increase or reduction amount of the current value is less in the second current value range than in the first current value range. Therefore, the set of current value information approaches an actual relation between the current value and the fan rotation speed. As a result, even when the fan rotation speed is deviated from the set value, the control unit can correct the fan rotation speed to the set value in a shorter time, and thereby, the cooling fan can be rotated at a more appropriate fan rotation speed.

Preferably, the set of current value information further has a third current value range in which the fan rotation speed is increased or reduced in accordance with the current value. The absolute value of the ratio of the increase or reduction amount of the fan rotation speed with respect to the increase or reduction amount of the current value is less in the third current value range than in the first current value range. The first current value range is a range set between the second current value range and the third current value range. It should be noted that the respective current value ranges are not overlapped with each other.

According to an exemplary embodiment of the present invention, the control unit can also correct the set current value to a current value within the third current value range. Therefore, a more appropriate amount of the operating oil can be supplied to the hydraulic motor.

A minimum current value in the second current value range can be set to be greater than a maximum current value in the first current value range.

Preferably, a maximum current value in the second current value range is set to be equal to a maximum current value in a fourth current value range to be controlled by the control unit. According to the configuration, the control unit can correct the current value up to the maximum current value in the fourth current value range.

Preferably, a maximum current value in the second current value range is greater than or equal to a value obtained by subtracting half an amplitude value of a dither signal from a maximum current value in a fourth current value range to be controlled by the control unit and is less than or equal to the maximum current value in the fourth current value range.

Preferably, the maximum current value in the second current value range is constant regardless of a temperature of the operating oil.

Preferably, the maximum current value in the second current value range is constant regardless of a rotation speed of the engine.

A maximum current value in the second current value range can be set to be less than a minimum current value in the first current value range.

Preferably, a minimum current value in the second current value range is set to be equal to a minimum current value in a fourth current value range to be controlled by the control unit. According to an exemplary embodiment of the present invention, the control unit can correct the current value down to the minimum current value in the fourth current value range.

Preferably, a minimum current value in the second current value range is greater than or equal to a minimum current value in a fourth current value range to be controlled by the control unit and is less than or equal to a value obtained by adding half an amplitude value of a dither signal to the minimum current value in the fourth current value range.

Preferably, the minimum current value in the second current value range is constant regardless of a temperature of the operating oil.

Preferably, the minimum current value in the second current value range is constant regardless of a rotation speed of the engine.

Preferably, the fan rotation speed is proportional to the current value in the first and second current value ranges. An absolute value of a proportional constant is greater in the first current value range than in the second current value range.

The hydraulic pump can be of a fixed capacity type. In this case, the work vehicle further includes a flow rate control valve. The flow rate control valve is configured to control the amount of the operating oil to be supplied to the hydraulic motor. Further, the electromagnetic proportional control valve is configured to control the amount of the operating oil by controlling the flow rate control valve.

The hydraulic pump may be of a variable capacity type. In this case, the electromagnetic proportional control valve is configured to control the amount of the operating oil to be supplied to the hydraulic motor by controlling the hydraulic pump.

According to exemplary embodiments of the present invention, a cooling fan can be rotated at an appropriate fan rotation speed.

### BRIEF DESCRIPTION OF THE DRAWINGS

FIG. 1 is a perspective view of a motor grader.

FIG. 2 is a side elevational view of the motor grader.

FIG. 3 is a hydraulic circuit diagram of a cooling mechanism.

FIG. 4 is a chart representing a set of current value information according to an exemplary embodiment of the present invention.

FIG. 5 is a flowchart representing an action of a control unit.

FIG. 6 is a chart representing a set of current value information according to another exemplary embodiment of the present invention.

FIG. 7 is a chart representing a set of current value information according to still another exemplary embodiment of the present invention.

FIG. 8 is a chart representing a set of current value information according to yet another exemplary embodiment of the present invention.

FIG. 9 is a hydraulic circuit diagram of a cooling mechanism according to another exemplary embodiment of the present invention including a spool valve.

### DETAILED DESCRIPTION OF EXEMPLARY EMBODIMENTS

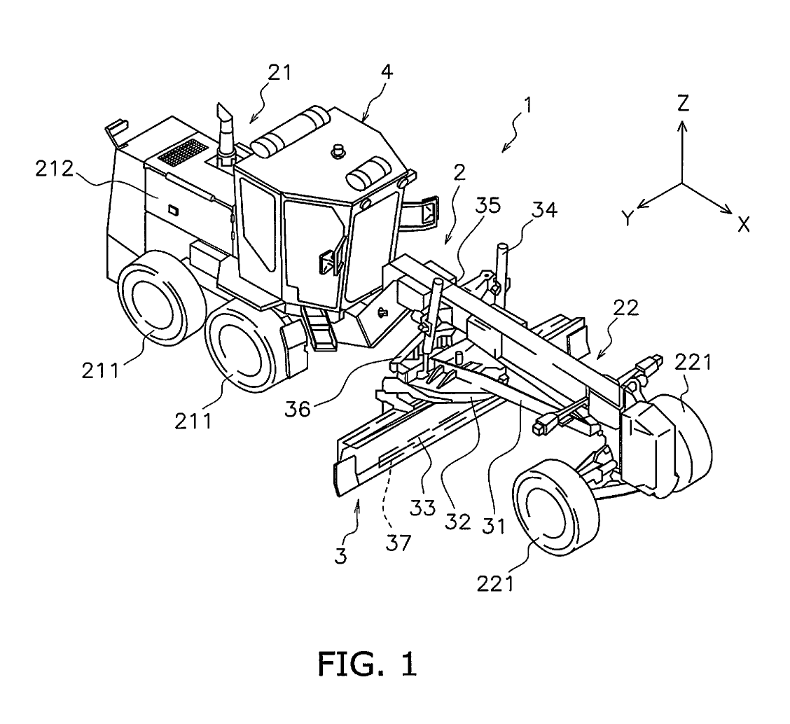

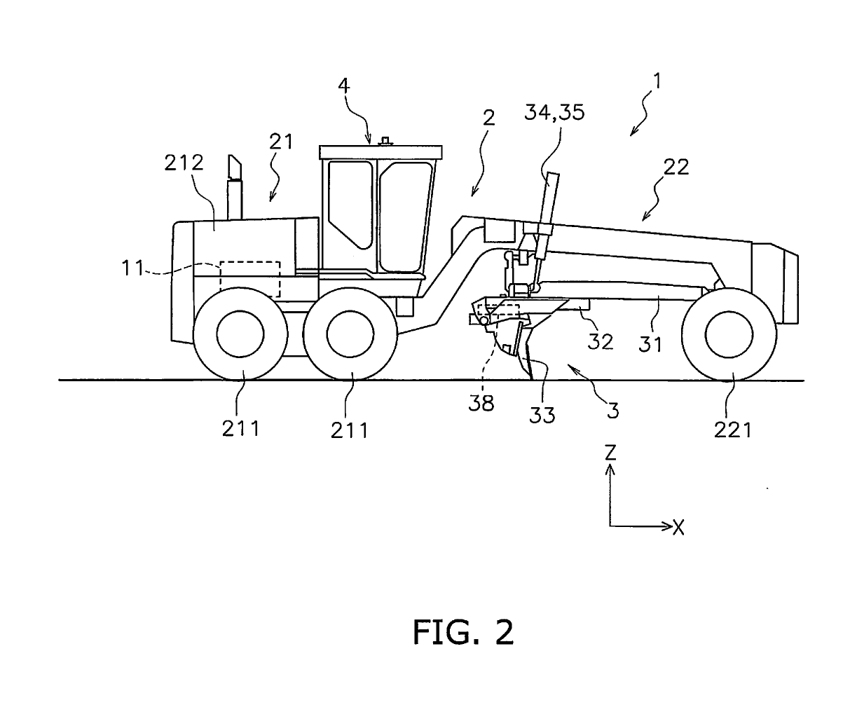

With reference to the drawings, explanation is hereinafter made for an exemplary embodiment of a motor grader (an exemplary work vehicle) according to the present invention. FIG. 1 is a perspective view of a motor grader, whereas FIG. 2 is a side elevational view of the motor grader.

As illustrated in FIGS. 1 and 2, a motor grader 1 includes a vehicle main body 2, a work implement 3 and a cab 4. The motor grader 1 can perform a variety of works (e.g., leveling, snow removal, light cutting, material mixture, etc.) by means of the work implement 3.

The vehicle main body 2 includes a rear-side vehicle body 21 and a front-side vehicle body 22. The rear-side vehicle body 21 has a plurality of (e.g., four) rear wheels 211. When these rear wheels 211 are rotationally driven by means of driving force from an engine 11, the motor grader 1 is caused to travel.

The rear-side vehicle body 21 has an engine compartment 212. The engine compartment 212 accommodates the engine 11. Further, the engine compartment 212 also accommodates a torque converter, a transmission and so forth (not illustrated in the drawings).

The torque converter is connected to an output side of the engine 11, and is configured to transmit power from the engine 11 to the transmission. The transmission is connected to an output side of the torque converter. The transmission includes clutches, shift gears and so forth (not illustrated in the drawings). The transmission is configured to transmit the power from the engine 11 to the rear wheels 211 through a final reducer and a tandem device (that are not illustrated in the drawings).

The front-side vehicle body 22 is disposed forward of the rear-side vehicle body 21. The front-side vehicle body 22 has a plurality of (e.g., two) front wheels 221. The front wheels 221 are disposed in the front part of the front-side vehicle body 22.

The work implement 3 includes a drawbar 31, a circle 32, a blade 33, a plurality of hydraulic cylinders 34 to 38, and so forth. The blade 33 is allowed to perform the following actions through the drawbar 31 and the circle 32: lifting up and down, tilt change with respect to the back-and-forth direction, tilt change with respect to the right-and-left direction, rotation, and shift in the right-and-left direction.

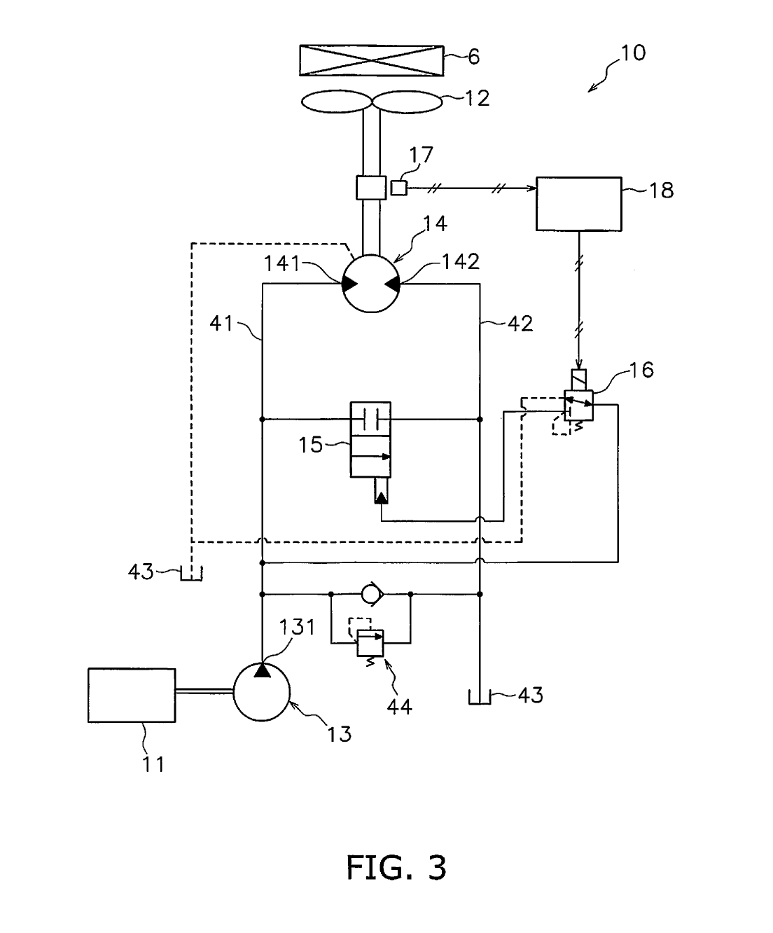

FIG. 3 is a hydraulic circuit diagram of a cooling mechanism. As represented in FIG. 3, the motor grader 1 further includes a cooling mechanism 10. The cooling mechanism 10 is a mechanism for cooling a cooling object, such as a radiator 6. For example, the cooling mechanism 10 is configured to rotate a cooling fan 12 to ventilate the radiator 6. Accordingly, the radiator 6 is cooled down. It should be noted that coolant water flows through the radiator 6 to cool down the engine 11 and so forth.

The cooling mechanism 10 includes the engine 11, the cooling fan 12, a hydraulic pump 13, a hydraulic motor 14, a flow rate control valve 15, an electromagnetic proportional control valve 16, a rotation sensor 17 and a control unit 18. The cooling mechanism 10 is, for instance, accommodated in the engine compartment 212.

The engine 11 is, for instance, a diesel engine. The output of the engine 11 is controlled by regulating the injection amount of fuel from a fuel injection pump (not illustrated in the drawings).

The cooling fan 12 is configured to be rotated for ventilating the radiator 6. The cooling fan 12 is attached to an output shaft of the hydraulic motor 14. The rotation sensor 17 is installed in the vicinity of the cooling fan 12. When described in detail, the rotation sensor 17 is installed in the vicinity of the output shaft of the hydraulic motor 14. The rotation sensor 17 is configured to detect a fan rotation speed that is the rotation speed of the cooling fan 12. Further, the rotation sensor 17 is configured to output a detection result to the control unit 18.

The hydraulic pump 13 is configured to be driven by the engine 11. The hydraulic pump 13 is of a fixed capacity type, and is configured to supply operating oil to the hydraulic motor 14. When described in detail, a supply path 41 is connected to a discharge port 131 of the hydraulic pump 13 to supply the operating oil to the hydraulic motor 14.

The hydraulic motor 14 is configured to rotate the cooling fan 12. The hydraulic motor 14 is configured to be driven by means of the operating oil to be discharged from the hydraulic pump 13. The hydraulic motor 14 has a supply port 141 and a discharge port 142.

The supply path 41 is connected to the supply port 141. In other words, the hydraulic pump 13 and the hydraulic motor 14 are connected through the supply path 41. The operating oil is supplied from the hydraulic pump 13 to the hydraulic motor 14 through the supply path 41.

A discharge path 42 is connected to the discharge port 142 of the hydraulic motor 14. The discharge path 42 connects the discharge port 142 and an operating oil tank 43. The operating oil within the hydraulic motor 14 is discharged to the operating oil tank 43 through the discharge path 42.

A safety valve 44 is connected to the supply path 41 and the discharge path 42. The safety valve 44 is configured to discharge the operating oil to the operating oil tank 43 when the pressure within the supply path 41 exceeds a preset pressure.

The flow rate control valve 15 is disposed between the hydraulic pump 13 and the hydraulic motor 14. The flow rate control valve 15 is configured to regulate the amount of the operating oil to be supplied to the hydraulic motor 14 from the hydraulic pump 13. When described in detail, the flow rate control valve 15 is connected to the supply path 41 and the discharge path 42. The flow rate control valve 15 is configured to regulate the amount of the operating oil to be supplied to the discharge path 42 from the supply path 41 by regulating the valve opening degree thereof. As a result, the flow rate control valve 15 can regulate the amount of the operating oil to be supplied to the hydraulic motor 14 from the hydraulic pump 13.

The electromagnetic proportional control valve 16 is configured to regulate the amount of the operating oil to be supplied to the hydraulic motor 14 from the hydraulic pump 13. When described in detail, the electromagnetic proportional control valve 16 is configured to regulate the amount of the operating oil to be supplied to the hydraulic motor 14 by controlling the flow rate control valve 15. When electric current is applied to the electromagnetic proportional control valve 16 from the control unit 18, the electromagnetic proportional control valve 16 is configured to be driven in accordance with the value of the current. Further, the hydraulic pressure, acting on the flow rate control valve 15, varies in accordance with the driving of the electromagnetic proportional control valve 16. As a result, the flow rate control valve 15 is controlled.

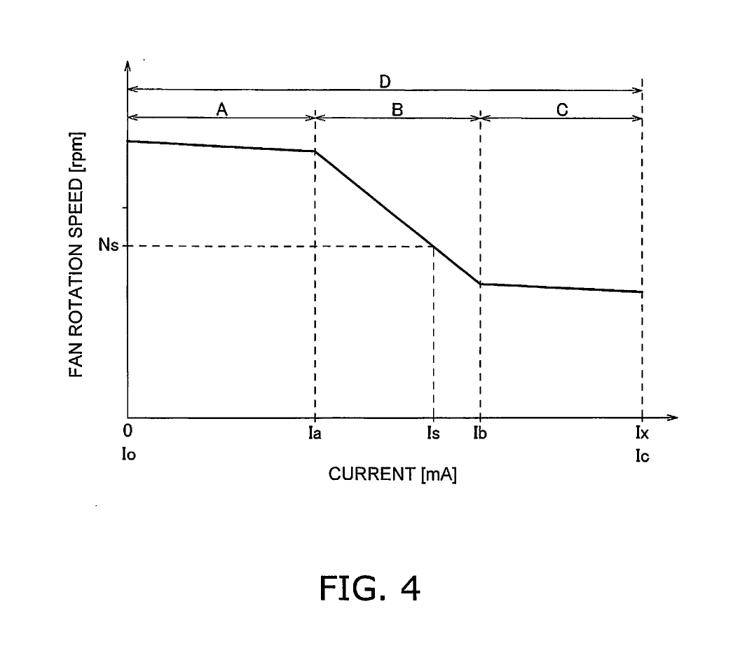

FIG. 4 is a chart of a set of current information indicating correspondence between the fan rotation speed and the current value. As represented in FIG. 4, the control unit 18 is configured to set a current value for driving the electromagnetic proportional control valve 16 on the basis of the current value information. It should be noted that the current value information is a set of information for indicating correspondence between the fan rotation speed and the current value. In other words, the current value information is a set of information for indicating a current value to be outputted to the electromagnetic proportional control valve 16 from the control unit 18 to rotate the cooling fan 12 at a given fan rotation speed. The control unit 18 stores the current value information.

Further, the control unit 18 is configured to perform feedback control. When described in detail, the control unit 18 is configured to correct a current value on the basis of the fan rotation speed detected by the rotation sensor 17. It should be noted that the current value to be corrected is a current value set based on the current value information.

The current value information has a low current value range (corresponding to a third current value range of the present invention) A, a middle current value range (corresponding to a first current value range of the present invention) B and a high current value range (corresponding to a second current value range) C. The respective current value ranges A, B and C are not overlapped with each other. Further, the respective current value ranges A, B and C are continuous to each other.

In the middle current value range B, the fan rotation speed is increased or reduced in accordance with the current value. When described in detail, in the middle current value range B, the fan rotation speed is reduced when the current value is increased. The middle current value range B is a current value range of greater than or equal to Ia and less than Ib. A ratio of the amount of increase or reduction in fan rotation speed with respect to the amount of increase or reduction in current value will be hereinafter referred to as “an increase or reduction ratio of the fan rotation speed”, whereas a ratio of reduction in fan rotation speed with respect to reduction in current value will be hereinafter referred to as “a reduction ratio of the fan rotation speed”. It should be noted that in the middle current value range B, the increase or reduction ratio of the fan rotation speed may be less when the current value is close to Ia and Ib than when the current value is other than these values.

In the high current value range C, the fan rotation speed is increased or reduced in accordance with the current value. When described in detail, the fan rotation speed is reduced when the current value is increased. The high current value range C is a current value range of greater than or equal to Ib and less than or equal to Ic. The maximum current value Ic in the high current value range C is equal to the maximum current value Ix in an entire current value range (corresponding to a fourth current value range of the present invention) D to be controlled by the control unit 18.

The absolute value of the increase or reduction ratio of the fan rotation speed in the high current value range C is less than that in the middle current value range B. When described in detail, the absolute value of the reduction ratio of the fan rotation speed in the high current value range C is less than that in the middle current value range B. For example, the reduction ratio of the fan rotation speed in the high current value range C can be set to be roughly greater than or equal to (1 rpm)/(50 mA) and less than or equal to (5 rpm)/(50 mA), and specifically, can be set to be roughly (2 rpm)/(50 mA).

In the low current value range A, the fan rotation speed is increased or reduced in accordance with the current value. When described in detail, the fan rotation speed is reduced when the current value is increased. The low current value range A is in a current value range of greater than or equal to Io and less than Ia. The minimum current value Io in the low current value range A is equal to the minimum current value 0 in the entire current value range D.

The absolute value of the increase or reduction ratio of the fan rotation speed in the low current value range A is less than that in the middle current value range B. When described in detail, the absolute value of the reduction ratio of the fan rotation speed in the low current value range A is less than that in the middle current value range B. For example, the reduction ratio of the fan rotation speed in the low current value range A can be set to be roughly equal to that in the high current value range C.

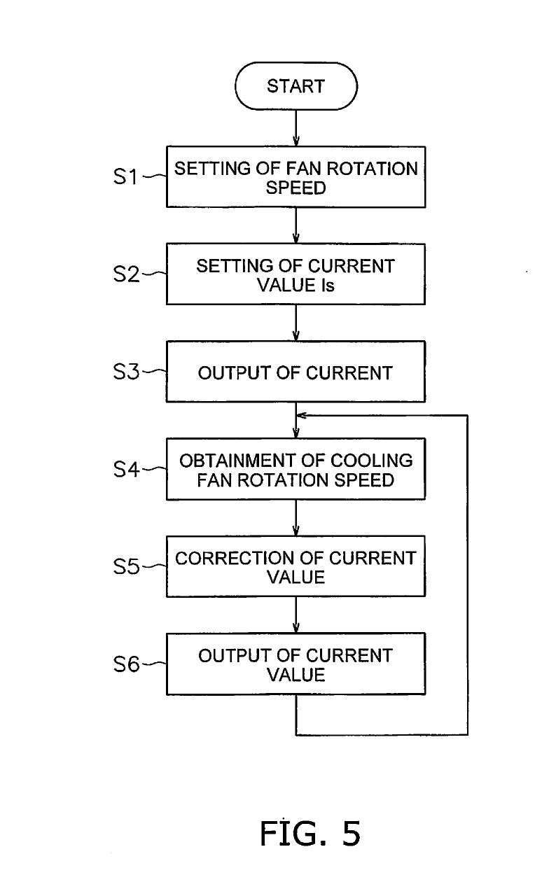

FIG. 5 is a flowchart for explaining an action of the control unit 18. As represented in FIG. 5, the control unit 18 first obtains information of a set value of the fan rotation speed (Step S1). When described in detail, the control unit 18 sets an appropriate fan rotation speed on the basis of the temperature of the radiator 6 and so forth. Alternatively, the control unit 18 obtains information of an appropriate fan rotation speed from another control unit and so forth, and sets the appropriate fan rotation speed. For example, the control unit 18 sets the appropriate fan rotation speed to be Ns (see FIG. 4).

Next, the control unit 18 sets a current value corresponding to the set fan rotation speed Ns on the basis of the current value information (Step S2). For example, the control unit 18 sets a current value Is corresponding to the set fan rotation speed Ns (see FIG. 4).

Next, the control unit 18 outputs a current with the set current value Is to the electromagnetic proportional control valve 16 (Step S3). As a result, the electromagnetic proportional control valve 16 and the flow rate control valve 15 are driven, and the amount of the operating oil to be supplied to the hydraulic pump 14 from the hydraulic pump 13 is controlled. Consequently, the cooling fan 12 is rotated at the set fan rotation speed Ns.

However, individual differences are produced in manufacturing products, such as the hydraulic motor 14. Therefore, even when the control unit 18 outputs a current with the current value Is to the electromagnetic proportional control valve 16, chances are that the actual fan rotation speed of the cooling fan 12 is not controlled at the set fan rotation speed Ns. Therefore, the control unit 18 obtains information of the actual fan rotation speed of the cooling fan 12 detected by the rotation sensor 17 (Step S4).

Next, the control unit 18 corrects the current value Is on the basis of the fan rotation speed information obtained in Step S4 (Step S5). In other words, the control unit 18 sets a new current value so as to rotate the cooling fan 12 at the set fan rotation speed Ns.

When described in detail, the control unit 18 determines whether or not the actual fan rotation speed is greater than the set fan rotation speed Ns on the basis of the fan rotation speed information obtained in Step S4.

When determining that the actual fan rotation speed is greater than the set fan rotation speed Ns, the control unit 18 sets a current value to be greater than the current value Is set in Step S2. On the other hand, when determining the actual fan rotation speed is less than the set fan rotation speed Ns, the control unit 18 sets a current value to be less than the current value Is set in Step S2.

In the processing of Step S5, the control unit 18 can correct the current value Is not only to a current value within the middle current value range B but also to a current value within the low current value range A or the high current value range C. In other words, the control unit 18 can correct the current value Is set in Step S2 to any of all the current values within the low current value range A, the middle current value range B and the high current value range C.

Next, the control unit 18 outputs the current value newly set in Step S5 to the electromagnetic proportional control valve 16 (Step S6). Then, the control unit 18 repeats the aforementioned processing of Step S4 and thereafter.

The motor grader 1 according to the present exemplary embodiment has the following features.

The control unit 18 sets the current value Is for driving the electromagnetic proportional control valve 16. Further, the control unit 18 can correct the set current value Is on the basis of the actual fan rotation speed detected by the rotation sensor 17. As a result, the electromagnetic proportional control valve 16 is driven by a current with a more appropriate value; a more appropriate amount of the operating oil is supplied to the hydraulic motor 14; and accordingly, the fan rotation speed approaches a set value. In other words, the cooling fan 12 can be rotated at a more appropriate fan rotation speed.

Further, the fan rotation speed is increased or reduced in accordance with the current value not only in the middle current value range B but also in the low current value range A and the high current value range C. Therefore, when the actual fan rotation speed is deviated from the set value, the control unit 18 can correct the current value Is not only to a current value within the middle current value range B but also to a current value within the low current value range A or a current value within the high current value range C. As a result, the control unit 18 can correct the set current value to a current value within a wider range, and a more appropriate amount of the operating oil can be supplied to the hydraulic motor 14. Therefore, the cooling fan 12 can be rotated at a more appropriate fan rotation speed.

Further, the absolute value of the increase or reduction amount of the fan rotation speed with respect to the increase or reduction amount of the current value is less in the low current value range A and the high current value range C than in the middle current value range B. Therefore, the current value information approaches an actual relation between the current value and the fan rotation speed. As a result, even when the fan rotation speed is deviated from the set value, the control unit 18 can correct the fan rotation speed to the set value in a shorter time, and thereby, the cooling fan 12 can be rotated at a more appropriate fan rotation speed.

An exemplary embodiment of the present invention is described above. However, the present invention is not limited to the aforementioned exemplary embodiment, and a variety of changes can be made without departing from the scope of the present invention.

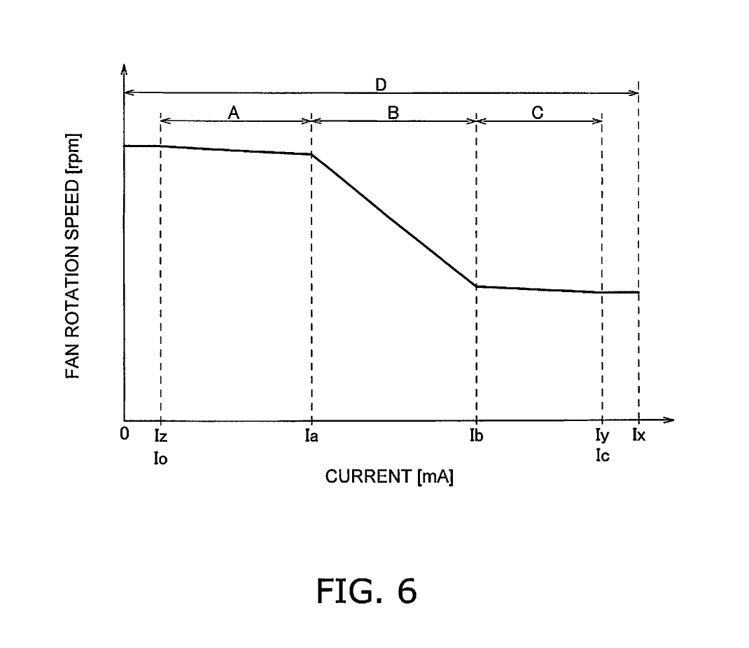

In the aforementioned exemplary embodiment, the maximum current value Ic in the high current value range C is equal to the maximum current value Ix in the entire current value range D. However, the present invention is not particularly limited to the configuration. It should be noted that as represented in FIG. 6, the maximum current value Ic in the high current value range C can be et to be roughly greater than or equal to a current value Iy and less than or equal to the current value Ix. For example, the current value Iy is a current value obtained by subtracting half an amplitude value of a dither signal from the maximum current value Ix in the entire current value range D. On the other hand, as described above, the current value Ix is the maximum current value in the entire current value range D. When specifically explained, where the maximum current value Ix is 1000 mA and the amplitude of the dither signal is 200 mA, the maximum current value Ic in the high current value range C can be set to be roughly greater than or equal to 900 mA and less than or equal to 1000 mA. It should be noted that the fan rotation speed is constant in a current value range between the maximum current value Ic in the high current value range C and the maximum current value Ix in the entire current value range D.

In the aforementioned exemplary embodiment, the minimum current value Io in the low current value range A is equal to the minimum current value 0 in the entire current value range D. However, the present invention is not particularly limited to the configuration. It should be noted that as represented in FIG. 6, the minimum current value Io in the low current value range A can be set to be roughly greater than or equal to 0 and less than or equal to a current value Iz. For example, the current value Iz is a current value obtained by adding half the amplitude value of the dither signal to the minimum current value in the entire current value range D. When specifically explained, where the minimum current value is 0 mA and the amplitude of the dither signal is 200 mA, the minimum current value Io in the low current value range A can be set to be roughly greater than or equal to 0 mA and less than or equal to 100 mA. It should be noted that the fan rotation speed is constant in a current value range between the minimum current value 0 in the entire current value range D and the minimum current value Io in the low current value range A.

The control unit 18 may set the current value on the basis of a plurality of sets of current value information. For example, the control unit 18 may have different sets of current value information to be used depending on oil temperature. For example, the control unit 18 has a set of first current value information and a set of second current value information. When the temperature of the operating oil is less than or equal to a first temperature, the control unit 18 is configured to use the first current value information. On the other hand, when the temperature of the operating oil is greater than or equal to a second temperature, the control unit 18 is configured to use the second current value information. It should be noted that the second temperature is higher than the first temperature. The low current value range A is wider in the second current value information than in the first current value information. Further, the high current value range C is wider in the second current value information than in the first current value information. In other words, the low current value range A and the high current value range C are set to be wider in the current value information relevant to a higher operating oil temperature. It should be noted that a total current value range of the low current value range A, the middle current value range B and the high current value range C in the first current value information is equal to that in the second current value information. Therefore, the middle current value range B is wider in the first current value information than in the second current value information.

The maximum current value Ic in the high current value range C is constant regardless of the temperature of the operating oil. In other words, the maximum current value Ic in the high current value range C in the first current value information is equal to that in the second current value information. Further, the minimum current value Io in the low current value range A is constant regardless of the temperature of the operating oil. In other words, the minimum current value Io in the low current value range A in the first current value information is equal to that in the second current value information.

It should be noted that the control unit 18 can calculate a set of current value information at a temperature between the first temperature and the second temperature on the basis of the first current value information and the second current value information. Further, the control unit 18 may have three or more different sets of current value information to be used depending on the temperature of the operating oil.

The control unit 18 may have different sets of current value information to be used depending on the engine speed. For example, the control unit 18 has a set of first current value information and a set of second current value information. When the engine 11 is rotated at a first engine speed, the control unit 18 is configured to use the first current value information. On the other hand, when the engine 11 is rotated at a second engine speed, the control unit 18 is configured to use the second current value information.

The first engine speed is greater than the second engine speed. The low current value range A is wider in the second current value information than in the first current value information. Further, the high current value range C is wider in the second current value information than in the first current value information. In other words, the low current value range A and the high current value range C are wider in the current value information relevant to the lower engine speed. It should be noted that the total current value range of the low current value range A, the middle current value range B and the high current value range C in the first current value information is equal to that in the second current value information. Therefore, the middle current value range B is wider in the first current value information than in the second current value information.

The maximum current value Ic in the high current value range C is constant regardless of the engine speed. In other words, the maximum current value Ic in the high current value range C in the first current value information is equal to that in the second current value information. Further, the minimum current value Io in the low current value range A is constant regardless of the engine speed. In other words, the minimum current value lo in the low current value range A in the first current value information is equal to that in the second current value information.

It should be noted that sets of current value information relevant to the other engine speeds can be calculated based on the first current value information and the second current value information. Alternatively, the control unit 18 may have three or more different sets of current value information to be used depending on the engine speed.

The aforementioned exemplary embodiment has been explained that the second current value range of the present invention corresponds to the high current value range C, whereas the third current value range of the present invention corresponds to the low current value range A. However, the present invention is not limited to the configuration. For example, the second current value range of the present invention may correspond to the low current value range A, whereas the third current value range of the present invention may correspond to the high current value range C.

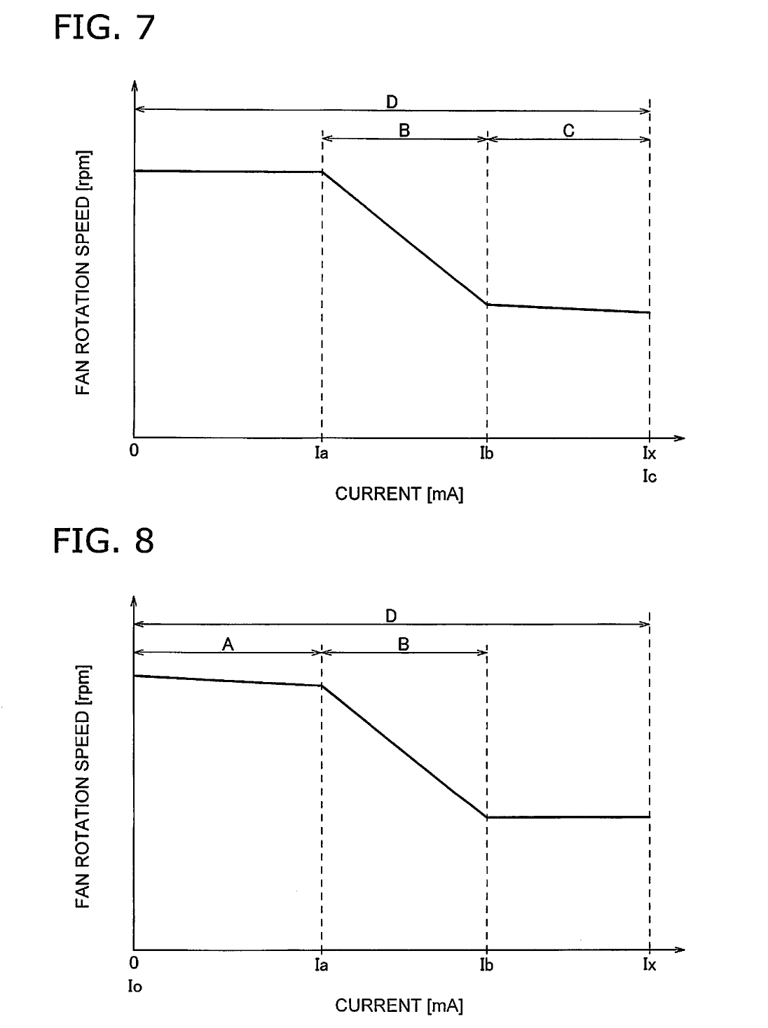

In the aforementioned exemplary embodiment, the control unit 18 is configured to have the low current value range A, the middle current value range B and the high current value range C as current value ranges in each of which the fan rotation speed is increased or reduced in accordance with the current value. However, the present invention is not limited to the configuration. For example, as represented in FIG. 7, the control unit 18 may have only the middle current value range B and the high current value range C as current value ranges in each of which the fan rotation speed is increased or reduced in accordance with the current value. It should be noted that the fan rotation speed is constant regardless of the current value in a current value range less than the minimum current value Ia of the middle current value range B.

As represented in FIG. 8, the control unit 18 may have only the low current value range A and the middle current value range B as current value ranges in each of which the fan rotation speed is increased or reduced in accordance with the current value. It should be noted that the fan rotation speed is constant regardless of the current value in a current value range greater than or equal to the maximum current value Ib of the middle current value range B.

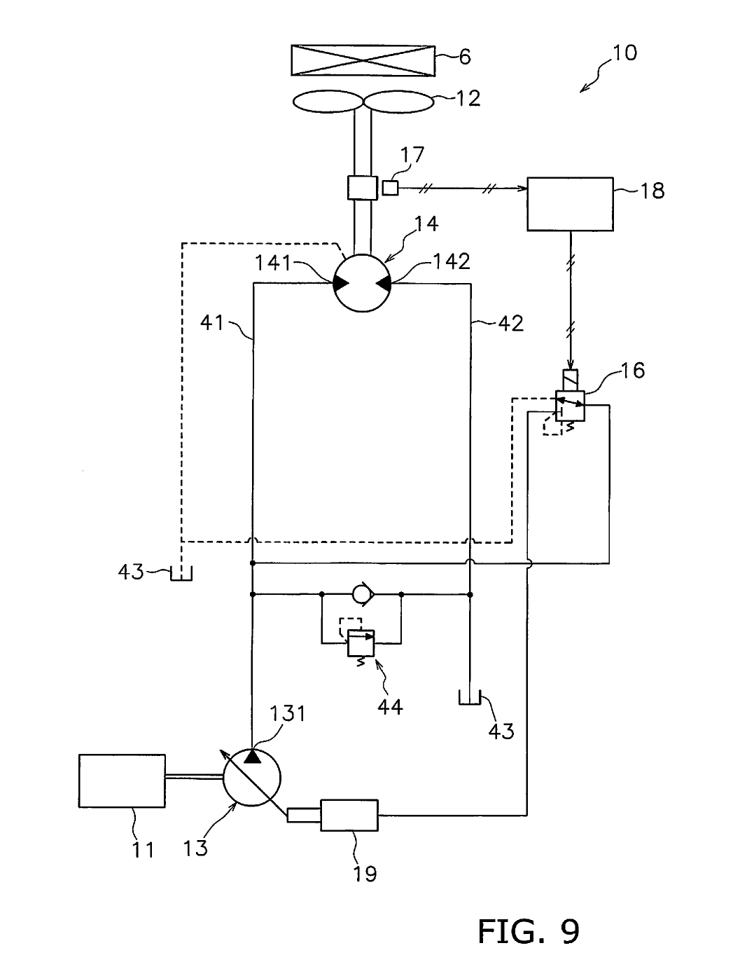

In the aforementioned exemplary embodiment, the hydraulic pump 13 is designed to be of a fixed capacity type. However, the hydraulic pump 13 is not particularly limited to the type. For example, the hydraulic pump 13 may be of a variable capacity type. FIG. 9 is a hydraulic circuit diagram representing a cooling mechanism according to another exemplary embodiment of the present invention.

As represented in FIG. 9, the cooling mechanism according to the modification 1 includes the engine 11, the cooling fan 12, the hydraulic pump 13, the hydraulic motor 14, the electromagnetic proportional control valve 16, the rotation sensor 17, the control unit 18 and a spool valve 19.

The electromagnetic proportional control valve 16 is configured to control the amount of the operating oil to be supplied to the hydraulic motor 14 by controlling the hydraulic pump 13. When described in detail, the electromagnetic proportional control valve 16 is configured to control pilot hydraulic pressure in accordance with a current value to be outputted from the control unit 18. The spool valve 19 is configured to control the tilt angle of a swash plate of the hydraulic pump 13 in accordance with the pilot hydraulic pressure controlled by the electromagnetic proportional control valve 16. As a result, it is possible to regulate the amount of the operating oil to be supplied to the hydraulic motor 14 from the hydraulic pump 13. It should be noted that the other structures are basically the same as those explained in the aforementioned exemplary embodiment. Therefore, detailed explanation thereof will not be hereinafter made.

The aforementioned exemplary embodiments have been explained by exemplifying the motor grader to which the present invention is applied. However, a work vehicle to which the present invention is applicable is not limited to the motor grader. For example, the present invention can be applied to a bulldozer, a wheel loader, a hydraulic excavator or so forth.

1. A work vehicle, comprising:
an engine;
a cooling fan;
a hydraulic pump configured to be driven by the engine;
a hydraulic motor configured to be driven by means of an operating oil discharged from the hydraulic pump and configured to rotate the cooling fan;
an electromagnetic proportional control valve configured to regulate an amount of the operating oil to be supplied to the hydraulic motor;
a rotation sensor configured to detect a fan rotation speed of the cooling fan; and
a control unit configured to set a current value for driving the electromagnetic proportional control valve based on a set of current value information indicating a correspondence between the fan rotation speed and the current value, wherein
the control unit is configured to correct the set current value based on the fan rotation speed detected by the rotation sensor,
the set of current value information has first and second current value ranges in each of which the fan rotation speed is increased or reduced in accordance with the current value,
the first current value range and the second current value range are continuous to each other, and
an absolute value of a ratio of an increase or reduction amount of the fan rotation speed with respect to an increase or reduction amount of the current value is less in the second current value range than in the first current value range.

2. The work vehicle according to claim 1, wherein
the set of current value information further has a third current value range in which the fan rotation speed is increased or reduced in accordance with the current value,
the absolute value of the ratio of increase or reduction in the fan rotation speed with respect to increase or reduction in the current value is less in the third current value range than in the first current value range, and
the first current value range is a range set between the second current value range and the third current value range.

3. The work vehicle according to claim 1, wherein the second current value range is positioned on a high current side of the first current value range.

4. The work vehicle according to claim 3, wherein a maximum current value in the second current value range is equal to a maximum current value in a fourth current value range to be controlled by the control unit.

5. The work vehicle according to claim 3, wherein a maximum current value in the second current value range is greater than or equal to a value obtained by subtracting half an amplitude value of a dither signal from a maximum current value in a fourth current value range to be controlled by the control unit and is less than or equal to the maximum current value in the fourth current value range.

6. The work vehicle according to claim 3, wherein a maximum current value in the second current value range is constant regardless of a temperature of the operating oil.

7. The work vehicle according to claim 3, wherein a maximum current value in the second current value range is constant regardless of a rotation speed of the engine.

8. The work vehicle according to claim 1, wherein the second current value range is positioned on a low current side of the first current value range.

9. The work vehicle according to claim 8, wherein a minimum current value in the second current value range is equal to a minimum current value in a fourth current value range to be controlled by the control unit.

10. The work vehicle according to claim 8, wherein a minimum current value in the second current value range is greater than or equal to a minimum current value in a fourth current value range to be controlled by the control unit and is less than or equal to a value obtained by adding half an amplitude value of a dither signal to the minimum current value in the fourth current value range.

11. The work vehicle according to claim 8, wherein a minimum current value in the second current value range is constant regardless of a temperature of the operating oil.

12. The work vehicle according to claim 8, wherein a minimum current value in the second current value range is constant regardless of a rotation speed of the engine.

13. The work vehicle according to claim 1, wherein
the fan rotation speed is proportional to the current value in the first and second current value ranges, and
an absolute value of a proportional constant is greater in the first current value range than in the second current value range.

14. The work vehicle according to claim 1, further comprising
a flow rate control valve configured to control the amount of the operating oil to be supplied to the hydraulic motor, wherein
the hydraulic pump is of a fixed capacity type, and
the electromagnetic proportional control valve is configured to control the amount of the operating oil to be supplied to the hydraulic motor by controlling the flow rate control valve.

15. The work vehicle according to claim 1, wherein
the hydraulic pump is of a variable capacity type, and
the electromagnetic proportional control valve is configured to control the amount of the operating oil to be supplied to the hydraulic motor by controlling the hydraulic pump.
